(19) United States
(12) Patent Application Publication
(10) Pub. No.: US 2013/0103865 A1
(43) Pub. Date: Apr. 25, 2013

(54) FLEXIBLE COMMUNICATIONS

(71) Applicants: STMicroelectronics (Grenoble 2) SAS, Grenoble (FR); STMicroelectronics Pvt. Ltd., Greater Noida (IN)

(72) Inventors: Ignazio Antonino Urzi, Voreppe (FR); Vivek Mohan Sharma, New Delhi (IN)

(21) Appl. No.: 13/658,667

(22) Filed: Oct. 23, 2012

(30) Foreign Application Priority Data
Oct. 25, 2011 (GB) 1118412.4

(51) Int. Cl. G06F 3/00

(52) U.S. Cl. 710/61

(57) ABSTRACT

A method for transmitting data on a configurable bus of z physical links, including receiving input data on an input bus at at least one of a plurality of data rates, selecting a number of physical links n, amongst the z physical links, on which data is to be transmitted, selecting a clock frequency f at which the data is to be transmitted on the configurable bus, wherein the selections of n and f are based on information concerning the at least one of the plurality of data rates, the number of links used on the input bus.

### CROSS REFERENCE TO RELATED APPLICATIONS

This application claims the priority benefit of Great Britain patent application number 1118412.4, filed on Oct. 25, 2011, which is hereby incorporated by reference to the maximum extent allowable by law.

### BACKGROUND

1. Technical Field

The present disclosure relates to communications between integrated circuits, and more particularly buses.

2. Discussion of the Related Art

It is common to share the various functions necessary for complex systems among a number of integrated circuits (henceforth IC's). In order for the system to work, the various integrated circuits communicate and share data. For this, they require various types of communication link, of which one type is a bus.

In general a bus has a set of physical wires or links over which data and instruction signals are sent and a protocol which is a set of steps the circuits using the bus apply so that the communications over the bus may take place correctly.

### SUMMARY

According to one embodiment, there is provided a method for transmitting data on a configurable bus comprising: receiving input data on an input bus at at least one of a plurality of data rates; selecting a number of physical links, from among a set of available physical links, on which data is to be transmitted, and selecting a clock frequency at which the data is to be transmitted on the configurable bus, wherein at least one of the selecting of the number of physical links and the selecting of the clock frequency are based on information on at least one of the plurality of data rates and the number of links used on the input bus.

The values of the number of physical links and the clock frequency may be selected to allow transmission of data on the configurable bus at a rate at least equal to the at least one of the plurality of data rates. The input data may be formatted into groups. The method may further comprise receiving a clock.

The method may comprise organizing said data into packets and providing a valid signal and a transmit clock signal. The method may comprise transmitting a proportion of packets corresponding to a start of said groups with a phase with respect to the clock. A proportion of the packets corresponding to the start of a group may be transmitted ahead of said first phase.

The method may comprise transmitting at least one of the packets containing a constant value between a packet corresponding to the end of a group and a packet corresponding to the beginning of the next group. The method may comprise transmitting a pulse on the valid signal when a packet corresponding to the start of a group is transmitted with said first phase.

The method may further comprise evaluating a packing density which represents a number of groups to be transmitted between successive valid pulses as a function of the number of physical links and the clock frequency. Evaluating the packing density may comprises the steps of: setting a value X to 0; 1. setting the packing density to 1; 2. calculating X=remainder of the integer division of (the number of links of the input bus+X) by (2×n); 3. If the remainder is non-zero, increasing the packing density by 1 and repeating step 3, 4. When X is found to be zero, stopping.

The method of may further comprise comparing the packing density to a storage limit and if the packing density exceeds the storage limit, increasing the number of physical links used on the input bus.

The method may comprise organizing the input data into frames and providing a frame synchronizing signal. The method may comprise transmitting the frame synchronizing signal from among packets on the configurable bus.

According to another embodiment, there is provided a method for receiving data on a configurable bus having a set of available physical links, comprising: receiving input data, supplied to a configurable bus receiver, in packets on a number of the available physical links, at a clock frequency; providing a clock; reformatting the packets into groups, and transmitting the data on an output bus at at least one of a plurality of data rates.

The input data may have been previously supplied at said at least one of a plurality of data rates and organized into packets.

According to another embodiment, there is provided a configurable bus transmitter, comprising: an output configured to drive a set of available physical links, and first circuitry for receiving data at at least one of a plurality of data rates, on an input bus, said input bus having a number of input links, wherein said first circuitry is configured to select a number of physical links, and a clock frequency based on information on the at least one of the plurality of data rates and the number of input links used on the input bus.

The first circuitry may be configured to reformat the data into packets and to provide a valid signal. The configurable bus transmitter may further comprising second circuitry configured to provide a transmit clock and transmit the transmit clock, the valid signal and packets over the selected physical links. Second circuitry may be configured to transmit the packets on both clock edges of the transmit clock.

The first circuitry may be coupled to the second circuitry by at least two parallel buses, a link for the valid signal and a link for the transmit clock signal. The configurable bus transmitter may further comprise a synchronization circuit configured to generate a frame synchronizing signal. The synchronization circuit may be configured to be clocked by a clock.

According to another embodiment, there may be provided a configurable bus receiver comprising an input configured to receive data on a number of physical links; formatting circuitry adapted to format the data; transmit circuitry adapted to transmit data on an output bus at the same data rate at which it was generated before transmission to the input.

The configurable bus receiver may comprise circuitry for generating a clock and transmitting said clock to a configurable bus transmitter.

According to another embodiment, there may be provided an equipment comprising at least one of a configurable bus transmitter according to the third aspect.

According to another embodiment, there may be provided an equipment comprising at least one of a configurable bus receiver according to the fourth aspect.

### BRIEF DESCRIPTION OF THE DRAWINGS

Some embodiments will now be described by way of example only with reference to the accompanying Drawings in which: FIG. 1 represents two ICs and a generalized bus between them;

FIG. 2 represents a pair of ICs comprising circuitry according to an embodiment;

FIG. 3a represents a timing diagram of signals transmitted according to an embodiment for a first case of an input data format;

FIG. 3b represents a timing diagram of signals transmitted according to an embodiment for a second case of an input data format;

FIG. 3c represents a timing diagram of signals transmitted according to an embodiment for a second case of an input data format;

FIG. 4 represents circuitry according to an embodiment for reformatting data for transmission;

FIG. 5 represents circuitry for reformatting data transmitted according to an embodiment in to a format for use by a downstream device; and

FIG. 6 represents a system according to an embodiment.

### DETAILED DESCRIPTION

The examples and embodiments in the following description are given in exemplary fashion only and without limitation.

In the interests of clarity, same references designate same elements. Also, features which have been described once will not be described in further detail. A signal name written with a suffix of the form [y] indicates that it is of the form of y parallel links. A suffix [w:u] refers to bits or links u to w of the signal concerned.

FIG. 1 represents a general case of first and second IC's 1, 2 (IC1, IC2) having a bus 3 connecting them. The bus 3 is composed of a number A of physical links, each link having a wire in some form or other connecting input/output (JO) cells on the two IC's 1,2. Each of these wires has a parasitic capacitance 4. This parasitic capacitance is largely produced between metal tracks and any grounds and it is contributed to by the metal tracks on the integrated circuits, the bond pads where the signals enter the integrated circuit and any connections between the circuits. Furthermore the IO cells consume power also.

The IO cell power consumption also has a static component i.e. there is power consumed without there being any activity. It is desirable to reduce this.

Also, when signals are sent over the bus, the capacitance is driven as a load and power is consumed. The power consumption for each wire increases with the product of frequency of the signal and the capacitive load. The bandwidth of the bus varies in a similar way with the frequency and the number of wires. Thus using higher bandwidths consumes, in general, more power. This power consumption can become significant and it is desirable to keep it as low as possible.

In many situations the volume of information that is to be transmitted between two given IC's varies significantly. This may be because the system is required to support a variety of information formats or applications. Downstream systems may consume the data at rates which vary significantly. However buses are in general of a fixed number of links. Also buses have either a fixed clock speed or are configured to transmit at the highest possible clock speed. In general buses are configured to have the maximum bandwidth needed amongst different information volumes. When the bandwidth required is low, this can be wasteful. It would be better that the bus be configured to an optimal setting of number of links and clock frequency.

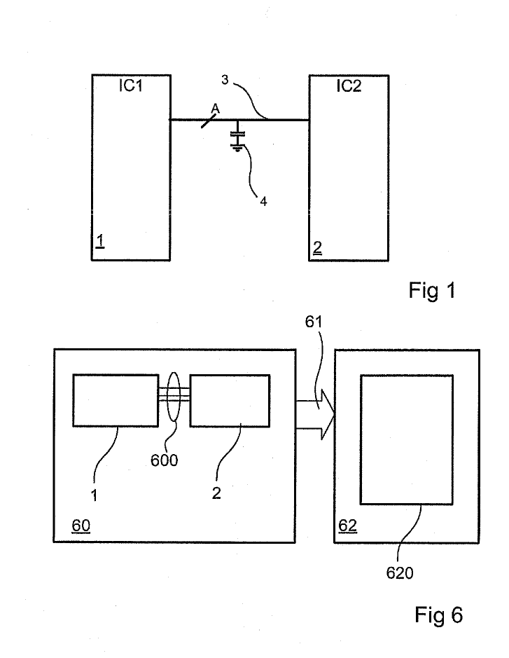

FIG. 2 represents first and second IC's 1, 2 being connected by a bus according to an embodiment. In the first IC 1, there is a data source 10 (SRC) which formats data which have been received from elsewhere (not shown) into the form that another downstream circuit (also not shown) may use it in. This organizing typically comprising putting the data into packets of the correct size and adding the clock, synchronization and other control signals that accompany the data.

The data source 10 formats data according to instructions from a controlling function (not shown). The data source 10 provides the formatted data over a parallel bus RD[z] of width z to a Transmit Packer 11 (TX pack) which reformats the data for transmission to a Physical Transmitter 12 (PHY_TX). Depending on the structure of the data i.e. number of bits per clock cycle, the data source 10 may use different numbers of links of the parallel bus RD[z].

The reformatted data is sent in packets, called or PHYTs, to the Physical Transmitter 12 in two streams PHYT_HI[n] and PHYT_LO[n], each over n parallel links. The Transmit Packer 10 also provides a signal VALID, which is used to indicate certain boundaries in the reformatted data. The Transmit Packer 11 receives a clock TX_CLK from the Physical Transmitter 12 which is used in the reformatting process and in the transmission to the second IC 2. The Transmit Packer 11 also receives a clock G_CLK. The clock G_CLK is also supplied to the data source 10 which uses it to clock the data onto the bus RD[z].

To perform the repacking, the Transmit Packer 11 makes use of FIFO (First In First Out) storage elements of depth FIFO_DEPTH. An embodiment of a Transmit Packer 11 will be discussed in more detail later. The Physical Transmitter 12 receives a clock signal from a phase-locked loop (or PLL) 13 (PLL) which is at twice the frequency of clock TX_CLK.

A synchronization generator 14 (SYNC) sends synchronization references signals 140 to the data source 10 and synchronization data 141 to the Transmit Packer 11. The synchronization generator is clocked by clock G_CLK.

The Physical Transmitter 12 combines the two streams PHYT_HT[n] and PHYT_LO[n] and transmits the data in a single stream PHYT[n] to the Physical Receiver 20 (PHY RX), in the second IC 2. It may be useful to us both edges of clock TX_CLK. The Physical Transmitter also is coupled by a link 120 for the clock TX_CLK and a link 121 for the VALID signal, to the Physical Receiver 20.

The Physical Receiver 20 performs, in general terms, the reverse of the Physical Transmitter 12 and reformats the data for transmission in third and fourth streams PHYT_HI[n], PHYT_LO[n]) each over n parallel links to a Receive Unpacker 21 (RX unpack). The Physical Receiver 20 also transmits a VA LID signal and a clock signal TX_CLK to the Receive Unpacker 21.

The Receive Unpacker 21 transforms the data back into the format in which it left the data source 10 and transmits it over z parallel links RD[z] to an output formatter 22 (OUT) which prepares the data for transmission to another downstream circuit or system (not shown). The number of links of used by the data source 10 to the Transmit Packer 11 is communicated by other means to the second IC 2.

A frequency synthesizer 23 (FS) generates the clock G_CLK. Clock G_CLK is also used by the Receive Unpacker 21 to synchronize the data transmissions to the output formatter 22, to which it is also supplied. Clock G_CLK may also be used by the downstream circuit or system for handling and using the data.

A controlling function with control links to all the above elements is present. This is not shown here in order to make the figure readable. This controlling function may either be in the form of code running on a processor or a hardware engine like a state machine. These choices are a trade-off between flexibility in terms of data formats supported and hardware size, speed and power consumption and are within the capabilities of the skilled person.

The controlling function makes a selection of transmit clock frequency and number of links of the n available links that will actually be used for the transmission is made. Based on the choices made, the Transmit Packer 11 repacks and retimes the data in a manner based on the volume of data and the rate at which it is to be supplied to the downstream circuit or system.

The controlling function makes an initial selection of the number, called IN_WIDTH, from a maximum of z, of the links of the bus RD[z] which will be used. The system controller also selects the frequency of clock G_CLK.

Then the controlling function makes an initial selection, called OUT_WIDTH, of the number of the physical links for the PHYT_HI, PHYT_LO and PHYT streams. Where the frequency of clock TX_CLK has been chosen, this number can be calculated by according to the equation:

$$out\_width = \frac{{F}_{P\_CLK}}{2 \times {F}_{TX\_CLK}} \times in\_width \qquad [ 1 ]$$

where F_{G}_{_{—}}_{CLK} and F_{TX}_{_{—}}_{CLK} are the frequencies of clocks G_CLK and TX_CLK respectively.

Since the number of links is an integer, the result for OUT_WIDTH is rounded up to the nearest integer when the result is not a whole number. This is to ensure that there are enough links to work with the frequency chosen for the clock TX_CLK.

Conversely, the frequency of TX_CLK may be selected according to the following equation

$${F}_{TX\_CLK} = \frac{in\_width}{2 \times out\_width} \times {F}_{P\_CLK} \qquad [ 2 ]$$

The product (F_{TX}_{_{—}}_{CLK}×OUT_WIDTH) may be significantly lower than the product (z×F_{G}_{_{—}}_{CLK}). However the effect of the rounding-up in equation [1] is that the product of (F_{TX}_{_{—}}_{CLK}×OUT_WIDTH) is higher for certain choices than others, making these choices less desirable from the point of view of power consumption.

It may be convenient to make the initial selections of the OUT_WIDTH based on the IN_WIDTH and frequency of clock G_CLK by reference to a look-up table which selects combinations of F_{TX}_{_{—}}_{CLK} and OUT_WIDTH giving their lowest product.

There are situations where there is a large volume of data being sent to downstream circuit or system as a stream. It may be required that the data be received in complete data groups within precise regular intervals. It may also be necessary that certain signals maintain a precise or constant relationship with each other. In such situations, it is common that synchronization signals be transmitted with the data. Also it may be necessary to ensure synchronization between the various processes of data reformatting (and its reverse) and transmission to ensure that the data is provided to the downstream circuit or system in a way respecting the timing constraints.

An example, given without limitation, of such a situation is video data being supplied to a display device. The groups in question are pixels and these should be received correctly in bundles between time periods of frame synchronization signals which mark successive video frames. In a case like this, the frame synchronization signals are also transmitted on the bus RD[z].

The Transmit Packer 11 therefore performs the repacking so as to ensure that the synchronization signals are transmitted to the second IC 2 so as to reach the output formatter 22 at the correct intervals.

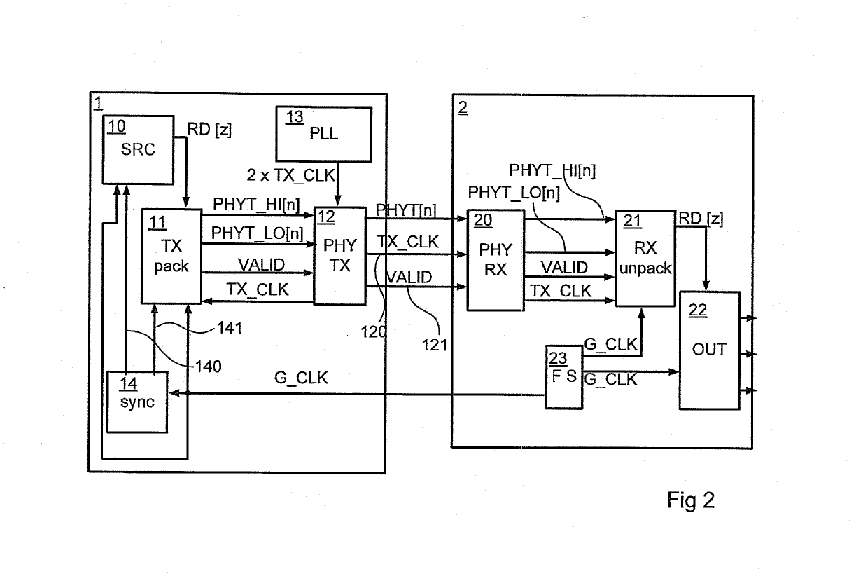

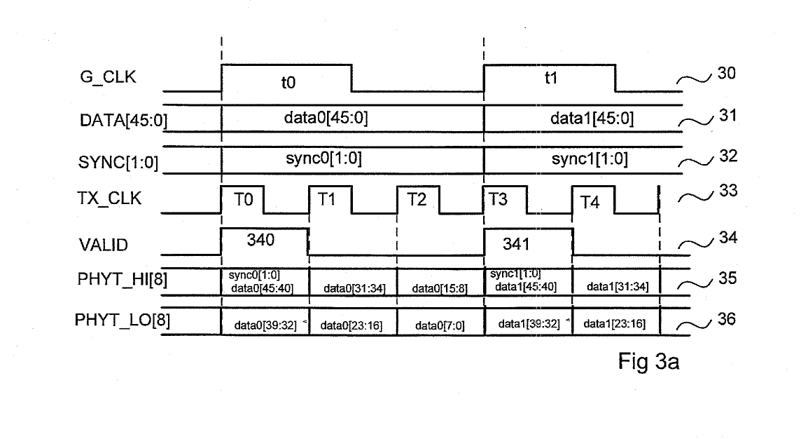

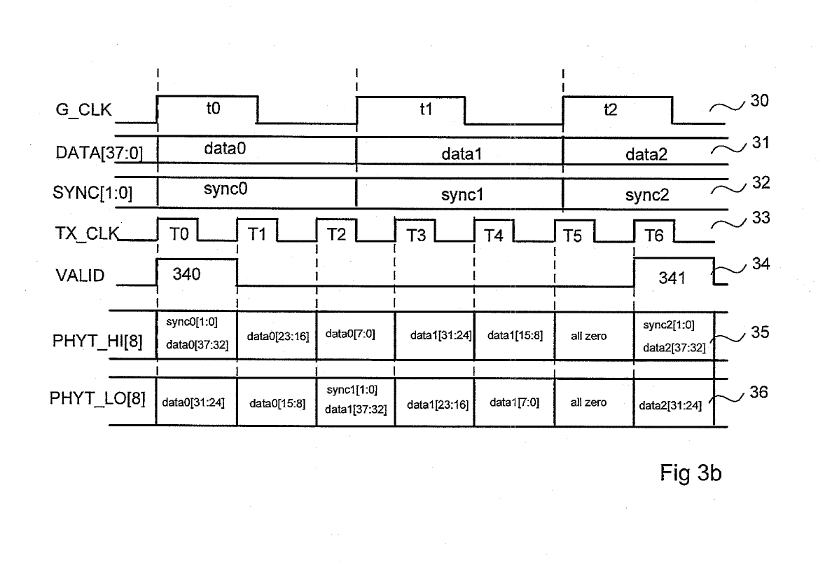

FIGS. 3a to 3c show timing diagrams illustrating the principles of the repacking and retiming of the data. Clock TX_CLK is shown as being in phase with clock G_CLK on the first positive edge. This is for readability and is not necessary the case in an actual system. Also the data packets on streams PHYT_HI[n] and PHYT_LO[n] are shown shifted to the left from some later time in order to make the figures easier to read. In reality, data would leave the Transmit Packer 11 some clock cycles later.

FIG. 3a represents the case where the frequency of clock G_CLK is 148.5 MHz, the IN_WIDTH is 48 (i.e. 48 lines are used on bus RD[z], and the OUT_WIDTH is 8. The minimum frequency of clock TX_CLK necessary is 445.5 MHz i.e. 3 times the frequency of clock G_CLK. To illustrate how the synchronization signals may be handled, a case of video data 46 bits per pixel clock of 148.5 MHz with horizontal and vertical synchronization bits is shown.

A first line 30 represents the clock G_CLK. A second line 31 represents the video data of 46 bits wide. A third line 32 represents the 2 bits of the horizontal and vertical synchronization signals. A fourth line 33 represents the clock TX_CLK. A fifth line 34 represents the VALID signal which indicates boundaries of successive groupings of PHYTs and is used by the Receive Unpacker 21 to rearrange the data back. Sixth and seventh lines 35, 36 represent the two streams PHYT_HI[n] and PHYT_LO[n].

Henceforth, in this example, where it is said that data is clocked on a pulse, it is to be understood that it is clocked on the rising edge. It is also possible to construct an implementation where falling edges are used and this is within the reach of the skilled person.

On a first pulse t0 of clock G_CLK, a data packet d0 of a first pixel and the corresponding synchronization signals s0 are sent on bus RD[48] and on a second pulse t1, a second pixel of data d1 and synchronization signals s1 are sent.

A first VALID pulse 340 is sent with a first pulse T0 of clock TX_CLK. On this pulse, the data for the pixel synchronization signals s0 is sent together with the data for bits 40 to 45 of pixel0 is sent on stream PHYT_HI[8]. In parallel, data for bits 32 to 39 of pixel0 is sent on stream PHYT_LO[8]. On a second pulse T1, data for bits 24 to 31 and bits 16 to 23 of pixel0 is sent on streams PHYT_HI[8] and PHYT_LO[8] respectively. On a pulse T2, data for bits 8 to 15 and bits 0 to 7 of frame0 is sent on streams PHYTHI[8] and PHYT_LO[8] respectively.

A second VALID pulse 341 is sent with a fourth pulse T3 of clock TX_CLK. On this pulse, the data for the frame synchronization signals s1 is sent together with the data for bits 40-45 of pixel1 on stream PHYT_HI[8]. In parallel, data for bits 32-39 of pixel1 is sent on stream PHYT_LO[8]. On a fifth pulse T4, data for bits 24-31 and bits 15-23 of frame1 is sent on streams PHYT_HI[8] and PHYT_LO[8] respectively. Data for bits 8-15 and bits 0-7 of pixel1 is sent on streams PHYT_HI[8] and PHYT_LO[8] respectively on a sixth pulse T5,

In this situation, it can be seen that the data for each frame is transmitted with the same time period as it is presented from the source 10. Also the packets containing the data for start of each new pixel are transmitted with the same phase relative to the clock G_CLK.

FIG. 3b represents a case where the data and synchronization signals are presented on 40 lines with a clock G_CLK of frequency 148.5 MHz. The IN_WIDTH is therefore 40. The OUT_WIDTH has been set to 8 which results in a minimum frequency of clock TX_CLK of 371.25 MHz which is 2.5 times the frequency of clock G_CLK.

On the pulse TO of TX_CLK, the data for synchronization signals s0 and data bits 32-37 of pixel0 are sent on stream PHYT_HI[8] while data bits 24-31 are sent on stream PHYT_LO[8]. A first VALID pulse 340 is also sent. On pulse T1, data bits 16-23 and 8-15 are sent on streams PHYT_HI[8] and PHYTLO[8] respectively. Then on pulse T2, data bits 0-7 of pixel0 are sent on stream PHYT_HI[8].

If the constraint of sending the synchronization data in time for the next pixel in real time is to be met, it is not possible to send synchronization signals s1 on stream PHYT_HI[8] on the next pulse of clock TX_CLK i.e T3 in the manner of the example of FIG. 3a. Therefore synchronization signals s1 and data bits 32-37 of pixel 1 are sent on stream PHYT_LO[8] on pulse T2 of clock TX_CLK. Otherwise the frequency of clock TX_CLK would have to be increased to at least 3×148.5 MHz, thereby increasing the power consumption. Thus synchronization signals s1 and data bits 32-37 of pixel1 are sent slightly ahead of the phase that the packets for the start of the pixel, i.e. bits 32-37 and 24-31 were sent.

Then, on T3, bits 24-31 and 16-23 of pixel 1 are sent on a streams PHYT_HI[8] and PHYT_LO[8] respectively. Finally with pulse T4, bits 8-15 and 0-7 of pixel1 are sent on streams PHYT_HI[8] and PHYT_LO[8] respectively.

FIG. 3c represents a third case. Here, the data and synchronization signals are presented on 40 lines with a clock G_CLK of frequency 297 MHz. The IN_WIDTH is therefore 40. The OUT_WIDTH has been set to 16 which results in a minimum frequency of clock TX_CLK of 371.25 MHz which is 1.25 times the frequency of clock G_CLK.

On pulses t0 to t4 of clock G_CLK, data and synchronization for pixels 0 to 4 are sent on bus RD[z].

On the pulse TO of clock TX_CLK, the data for synchronization signals s0 and data bits 24-37 of pixel0 are sent on stream PHYT_HI[8] while data bits 8-24 are sent on stream PHYT_LO[8]. A first VALID pulse 340 is also sent. On pulse T1, data bits 0-7 of pixel0, the synchronization data for pixel1 and data bits 32-35 for pixel1 are sent on stream PHYT_HI[8] while data bits 16-31 of pixel 1 are sent on stream PHYT_LO[8]. Then on pulse T2, data bits 0-15 of pixel0 are sent on stream PHYT_HI[8].

As for FIG. 3b, if the constraint of sending the synchronization data in time for the next pixel in real time is to be met, it is not possible to send s1 on stream PHYT_HI[8] on pulse T3 of clock TX_CLK. Therefore synchronization and data bits 24-35 of pixel1 are sent on stream PHYT_LO[8] on pulse T2 of clock TX_CLK which means that they are ahead of the phase that the packet of bit 24-27 has relative to clock G_CLK.

Then, on pulse T3, bits 8-23 and 16-23 of pixel1 are sent on stream PHYT_HI[8] while on stream PHYT_LO[8], data bits 0-7 of pixel1 and synchronization and data bits 24-35 of pixel2 are sent.

Finally with pulse T4, bits 16-31 and 0-15 of pixel2 are sent on streams PHYT_HI[8] and PHYT_LO[8] respectively. For pulse T5, all zeros are transmitted as padding. Then with pulse T6, a second VALID pulse 341 is produced and transmission for pixel3 commences.

The early transmission of the synchronization and data bits and the padding with zeros avoids increasing the frequency of clock TX_CLK to 2×297 MHz, thus avoiding extra power consumption. The signal VALID indicates where the data transmitted in stream PHYT is no longer being sent in advance and the padding with zeros has finished for that set of pixels.

The number of data groups present in the source data for which data is sent per VALID signal period is called the packing density. This packing density is limited by the depth of the FIFOs in the Transmit Packer 11. For many implementations, this limit, the maximum packing density, will be 0.5×FIFO_DEPTH though one of ordinary skill will be able to determine the actual limit.

The packing density may be calculated using the following algorithm

| | |
|---|---|
| 1. | Set X = 0 |
| 2. | Set packing density = 1 |
| 3. | Calculate X = remainder of (IN_WIDTH + X) / (2 x OUT_WIDTH) |
| 4. | If X is non-zero then |

Set packing density = packing density + 1
Return to step 3

| | |
|---|---|
| | else |
| 5. | If packing density is less than the maximum packing density then |

Exit

| | |
|---|---|
| | else |
| 6. | Increment IN_WIDTH by 1 and return to step 1. |

For step 6 the source 10 will be reconfigured to transmit on an extra link of the bus RD[z]. In this case, early transmission of data and synchronization and padding with zeros will be used.

The following table gives some examples of results from typical video applications. The video data is represented in an RGB color space with equal numbers of bits for each color component. The two examples of FIG. 3b and FIG. 3c are shown for comparison.

| | | | | Pixel | TX | | |
|---|---|---|---|---|---|---|---|
| | RGB | Alpha | bits/ | clock | clock | Out | pack- |
| Mode | size | size | pixel | (MHz) | (MHz) | width | ing |
| DVO 12 | 36 | 8 | 46 | 148.5 | 445.5 | 8 | 1 |
| ARGB | | | | | | | |
| 1080p60 | | | | | | | |
| Main 14 RGB | 42 | 0 | 44 | 148.5 | 445.5 | 8 | 1 |
| 1080p60 | | | | | | | |
| Main 10 RGB | 30 | 0 | 32 | 148.5 | 297 | 8 | 1 |
| 1080p60 | | | | | | | |
| Main 10 RGB | 30 | 0 | 32 | 74.25 | 148.5 | 8 | 1 |
| 1080i60 | | | | | | | |
| Aux 8 RGB | 24 | 0 | 26 | 13.5 | 94.5 | 2 | 1 |
| 480i60 | | | | | | | |
| Other format 1 | | | 40 | 148.5 | 371.25 | 8 | 2 |
| Other format 2 | | | 40 | 297 | 371.25 | 16 | 4 |

Alpha column refers to a data bits indicating the transparency level (this is used during picture overlaying).

As can be seen, for the named video formats, the clock TX_CLK is an integer multiple of clock G_CLK. However non-integer multiples may be used where convenient, as shown in the last two examples.

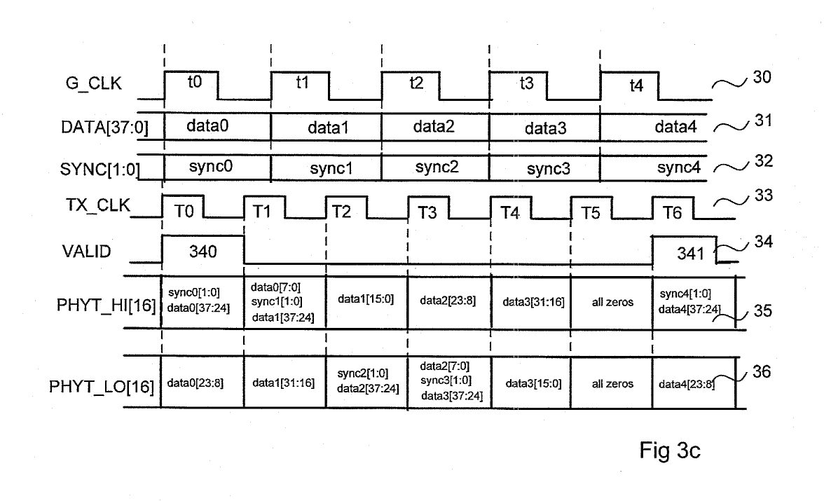

FIG. 4 represents an exemplary architecture of a Transmit Packer 11 according to an embodiment. This embodiment may be adapted to handling video data streams. In this example the data is video data in an RGB color space. Therefore there are three color components.

A data aligner 40 (Dat a Aligner) receives synchronization signals SYNC[U] and enable signals EN[V]. In the case of a video application, these could be horizontal and vertical sync, the video and graphics enable signals respectively. It also receives data on a number of links equal to IN_WIDTH of bus RD[z]. It outputs the data on bus of 3×IN_WIDTH+the number of links of SYNC and EN signals and this is clocked into a RAM (random access memory) 41 (RAM) on by the clock GCLK.

A write-FIFO 42 (Write FIFO), which is also clocked by the clock G_CLK, controls the data writes with a signal WR_ADDR and WR_EN to the RAM 41. The write-FIFO 42 signals the data write to a read-FIFO 43 (Read FIFO) by incrementing a signal RD_PTRG.

The read-FIFO 43 receives clock G_CLK and sends read address signal RD_ADDR to the RAM 41 . . . to control the output of the data on a bus of width 3×IN_WIDTH+the number of links of SYNC and EN signals to a data packer 44 (Data Packer). The read-FIFO 34 also supplies a signal VALID to the Physical Transmitter 12. The read-FIFO 43 signals data reads from the RAM 41 to the write-FIFO 42 using a signal WR_PTRG.

The data packer 44 also receives a phase signal PACK_PHASE from the read-FIFO 43. Finally the data packer 44 outputs the PHYT_HI[n] and PHYT_LO[n] signals to the Physical Transmitter 12, where n is set to the OUT_WIDTH

The RAM 41, write-FIFO 42 and read-FIFO 43 function as a circular buffer transfer the data from the domain of clock G_CLK to that of clock TX_CLK. Under the control of the PACK_PHASE signal, the data packer 44 re-packs the data and transmits it on PHYT_HI and PHYT_LO streams of width OUT_WIDTH.

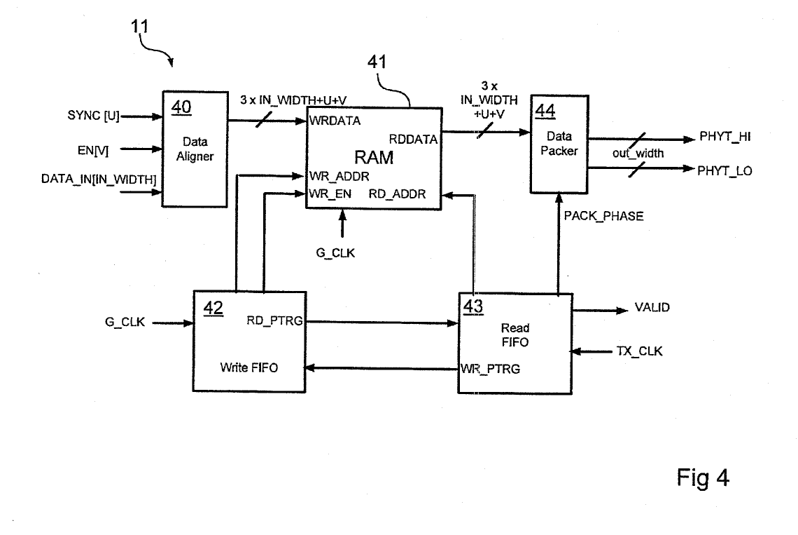

FIG. 5 represents an exemplary architecture of a Receive Unpacker 20 according to an embodiment. This embodiment is particularly well adapted to handling video data streams.

From the Physical Receiver 20, a data depacker 50 (Data Depacker) receives the data as PHYT_HI[n] and PHYT_LO[n] streams where n is equal to OUT_WIDTH. It supplies data on a bus of 3×OUT_WIDTH+the width of the SYN and EN signals to a RAM 51 (RAM). Data is clocked in on clock TX_CLK, under the control of a write-address pointer WRADDR from a write-FIFO 52 (Write FIFO) which is also clocked by clock TX_CLK. The write-FIFO 52 signals the write by a RD_PTRG to a read-FIFO 53 (Read FIFO). The read-FIFO 53 is clocked by clock G_CLK and clocks data out of the RAM 51 by using a read-address pointer RDADDR supplied to the RAM 51. The data is output from the RAM 51 on a bus and contains the data[IN_WIDTH], SYNC[U] and EN[V] signals. The output of data from the RAM 51 is flagged by the read-FIFO 53 to the write-FIFO 52 using a signal WR_PTRG.

In the examples of FIG. 5, the reason that the data streams have the factor of 3, as in 3×OUT_WIDTH, is because these examples are for an RGB color space with 3 color components. In other situation, this multiple would be that of the number of components. In certain situations, like this where the data is video data, the clock G_CLK may be referred to as the pixel clock and is the clock used to clock each pixel in the display device downstream.

The read and write-FIFOs 42 and 43 are those referred to in the discussion concerning FIG. 3.

Thus the number of physical links used is reduced at a penalty of a slightly increased clock rate. For example, a bus of width 48 at a clock frequency of 148.5 MHz may be repacked to one of width 8 at 445.5 MHz. This saves the static consumption of 40 IO cells on each of the two IC's 1,2 whilst not substantially increasing the dynamic consumption. Depending on the actual implementation and the relative contributions of the static and dynamic power consumptions, the power saving may vary. It has been found that this may save over 50% of the power. Therefore it is possible to keep the power consumption at a lower level than would otherwise be possible with conventional buses.

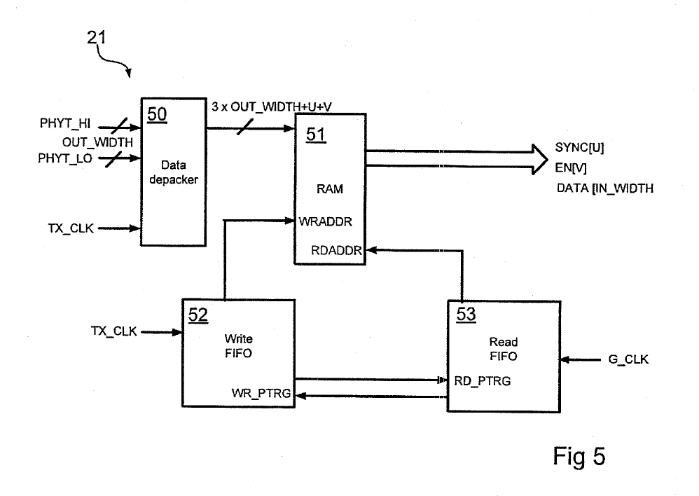

FIG. 6 represents a system having a first device 60 transmitting video data over a link 61 to a second device 62. The first device 60 has first and second ICs 1 and 2 communicating over a link 600, all according to an embodiment. The second device 62 has a screen 620 for displaying the video data. Examples of the first device 60 include, without limitation, satellite and cable receiver-demodulators and examples of the second device 62 include, also without limitation, televisions and monitors. The link 61 may be according to any of the known standards or formats.

In the foregoing, reference is made to applications concerning video data. However, in other situations where the required bandwidth varies significantly, embodiments described herein could permit power saving. The ability of these embodiments to take into account tight synchronization constraints like those present with video data mean that they could handle less stringent situation. Furthermore, because any synchronized signals are transmitted with the data in stream PHYT, the problem of maintaining synchronization with dedicated synchronization paths is avoided. Therefore flexibility with respect to the relationship between them and the data is preserved since this relationship is managed by the data source 10 and the synchronization generator 14, which may be adapted by one of ordinary skill.

Having thus described at least one illustrative embodiment of the invention, various alterations, modifications, and improvements will readily occur to those skilled in the art. Such alterations, modifications, and improvements are intended to be within the spirit and scope of the invention. Accordingly, the foregoing description is by way of example only and is not intended as limiting. The invention is limited only as defined in the following claims and the equivalents thereto.

What is claimed is:

1. A method for transmitting data on a configurable bus comprising:
receiving input data on an input bus at at least one of a plurality of data rates;
selecting a number of physical links, from among a set of available physical links, on which data is to be transmitted, and
selecting a clock frequency at which the data is to be transmitted on the configurable bus,
wherein at least one of the selecting of the number of physical links and the selecting of the clock frequency are based on information on at least one of the plurality of data rates and the number of links used on the input bus.

2. The method of claim 1, wherein the values of the number of physical links and the clock frequency are selected to allow transmission of data on the configurable bus at a rate at least equal to the at least one of the plurality of data rates.

3. The method of claim either of claim 1, wherein the input data is formatted into groups.

4. The method of claim 3 further comprising receiving a clock.

5. The method of claim 1, comprising organizing said data into packets and providing a valid signal and a transmit clock signal.

6. The method of claim 5, comprising transmitting a proportion of packets corresponding to a start of said groups with a first phase with respect to the clock.

7. The method of claim 6 wherein a proportion of the packets corresponding to the start of a group may be transmitted ahead of said first phase.

8. The method of either of claim 6, comprising transmitting at least one of the packets containing a constant value between a packet corresponding to the end of a group and a packet corresponding to the beginning of the next group.

9. The method of claim 6, comprising transmitting a pulse on the valid signal when a packet corresponding to the start of a group is transmitted with said first phase.

10. The method of claim 9, further comprising evaluating a packing density which represents a number of groups to be transmitted between successive valid pulses as a function of the number of physical links and the clock frequency.

11. The method of claim 10, wherein evaluating the packing density comprises the steps of:
1. setting a value X to 0;
2. setting the packing density to 1;
3. calculating X=remainder of the integer division of (the number of links of the input bus+X) by (2×n);
4. If the remainder is non-zero, increasing the packing density by 1 and repeating step 3
5. When X is found to be zero, stopping.

12. The method of claim 11, further comprising comparing the packing density to a storage limit and if the packing density exceeds the storage limit, increasing the number of physical links used on the input bus.

13. The method of claim 1, comprising organizing the input data into frames and providing a frame synchronizing signal.

14. The method of claim 13, comprising transmitting the frame synchronizing signal from among packets on the configurable bus.

15. A method for receiving data on a configurable bus having a set of available physical links, comprising:
receiving input data, supplied to a configurable bus receiver, in packets on a number of the available physical links, at a clock frequency;
providing a clock;
reformatting the packets into groups, and
transmitting the data on an output bus at at least one of a plurality of data rates.

16. The method of claim 15, wherein the input data was previously supplied at said at least one of a plurality of data rates and organized into packets.

17. A configurable bus transmitter, comprising:
an output configured to drive a set of available physical links, and
first circuitry for receiving data at at least one of a plurality of data rates, on an input bus, said input bus having a number of input links,
wherein said first circuitry is configured to select a number of physical links, and a clock frequency based on information on the at least one of the plurality of data rates and the number of input links used on the input bus.

18. The configurable bus transmitter of claim 17, wherein said first circuitry is configured to reformat the data into packets and to provide a valid signal.

19. The configurable bus transmitter of claim 17, further comprising second circuitry configured to provide a transmit clock and transmit the transmit clock, the valid signal and packets over the selected physical links.

20. The configurable bus transmitter of claim 19, wherein second circuitry is configured to transmit the packets on both clock edges of the transmit clock.

21. The configurable bus transmitter of claim 19, wherein first circuitry is coupled to the second circuitry by at least two parallel buses, a link for the valid signal and a link for the transmit clock signal.

22. The configurable bus transmitter of claim 17, further comprising a synchronization circuit configured to generate a frame synchronizing signal.

23. The configurable bus transmitter of claim 22 wherein the synchronization circuit is configured to be clocked by a clock.

24. A configurable bus receiver comprising
an input configured to receive data on a number of physical links;
formatting circuitry adapted to format the data;
transmit circuitry adapted to transmit data on an output bus at the same data rate at which it was generated before transmission to the input.

25. The configurable bus receiver of claim 24, further comprising circuitry for generating a clock and transmitting said clock to a configurable bus transmitter.

26. An equipment comprising at least one of a configurable bus transmitter according to claim 17.

27. An equipment comprising at least one of a configurable bus receiver according to claim 24.
